(19) United States
(12) Patent Application Publication
(10) Pub. No.: US 2024/0418228 A1
(43) Pub. Date: Dec. 19, 2024

(54) AIR ACTUATED DISC BRAKE

(71) Applicant: BRAKES INDIA PRIVATE LIMITED, Chennai, Tamil Nadu (IN)

(72) Inventors: B, Govindaraj, Chennai, Tamil Nadu (IN); S, Senthil Kumar, Chennai, Tamil Nadu (IN); K, Nithin, Chennai, Tamil Nadu (IN)

(21) Appl. No.: 18/718,767

(22) PCT Filed: Jan. 4, 2023
(86) PCT No.: PCT/IB2023/050054

§ 371 Date: Jun. 11, 2024

(30) Foreign Application Priority Data
Dec. 11, 2021 (IN) 202141057699

(51) Int. Cl. F16D 55/226; F16D 55/00; F16D 121/04

(52) U.S. Cl. CPC F16D 55/226; F16D 2055/0016; F16D 2121/04

(57) ABSTRACT

A single piston air actuated disc brake with reduced taper wear of brake pads is disclosed. Said single piston air disc brake comprises a caliper (14); a piston (6); a carrier (5); an inboard pad (1); and an outboard pad (2). A centreline line (12) of both the inboard pad (1) and the outboard pad (2) are offset towards a leading side (15) of the carrier (5) for a predefined distance from the centreline (11) of the piston (6). The inboard leading abutment (10) and the outboard leading abutment (8) are configured as thinner than the inboard trailing abutment (13) and the outboard trailing abutment (9), respectively. The thickness of first back plate (1a) of the inboard pad (1) is configured as about 1.5 times to 2 times thicker than the thickness of the second back plate (2a) of the outboard pad (2). The disclosed single piston air disc brake is configured to reduce the taper wear of brake pads, thereby increases the life of the brake pads.

### FIELD OF THE INVENTION

The present disclosure is generally related to an air actuated disc brake. Particularly, the present disclosure is related to taper wear of brake pads used in a single piston air disc brake. More particularly, the present disclosure is related to a single piston air actuated disc brake with reduced taper wear of brake pads.

### BACKGROUND OF THE INVENTION

Air disc brakes used in vehicles, such as commercial buses and trucks are either twin piston air disc brakes or single piston, depending on the application requirement of a vehicle. A brake pad is one of the critical and essential serviceable components in the air disc brakes.

During braking, inboard brake pads at a piston side and outboard pads at the opposite side of the piston are subjected to both clamp and torsional loads. These loads get transferred from the piston to a rotor through brake pads.

The brake pads used in the single piston air disc brakes are more prone to excess taper wear that as compared to that of the twin piston air disc brakes. However, higher life of a component is always a market demand.

One such disc brake that reduces taper wear of brake pads has been disclosed in European Patent EP2392835B1. In which a brake pad disposed at an inboard is offset while the brake pad disposed at an outboard is aligned with the piston centre. Since the load centre between the inboard brake pad and the outboard brake pad is offset, thus results in load coupling on a rotor and the brake, thereby causes failure effects on the rotor and the brake.

There are many solutions have been proposed. However, no comprehensive and cos-effective solution has been proposed so far to address the aforementioned and long-standing problem.

There is, therefore, a need in the art for a method of reducing taper wear of brake pads used in single piston air disc brakes, which overcomes the aforementioned drawbacks and shortcomings.

### SUMMARY OF THE INVENTION

A single piston air disc brake with reduced taper wear of brake pads is disclosed. Said single piston air disc brake comprises a caliper; a piston; a carrier; an inboard pad; and an outboard pad.

The carrier comprising an inboard side, an outboard side, an inboard leading abutment, an inboard trailing abutment, an outboard leading abutment, and an outboard trailing abutment.

The inboard pad comprises a first back plate and a first friction material, and has a first leading edge and a first trailing edge. Said inboard pad is disposed between the inboard leading abutment and the inboard trailing abutment of the carrier;

The outboard pad comprises a second back plate and a second friction material, and has a second leading edge and a second trailing edge, with said outboard pad is disposed between the outboard leading abutment and the outboard trailing abutment of the carrier.

A centreline line of both the inboard pad and the outboard pad are offset towards a leading side of the carrier for a predefined distance from the centreline of the piston.

The inboard leading abutment and the outboard leading abutment are configured as thinner than the inboard trailing abutment and the outboard trailing abutment, respectively depending on the offsetting of the inboard pad and the outboard pad.

The thickness of first back plate of the inboard pad is configured as about 1.5 times to about 2 times thicker than the thickness of the second back plate of the outboard pad.

The disclosed single piston air disc brake is configured to reduce the taper wear of brake pads, thereby increases the life of the brake pads.

### BRIEF DESCRIPTION OF THE DRAWINGS

FIG. 1 illustrates brake pads used in single piston air disc brakes with tangential taper wear, in accordance with the present disclosure;

FIG. 2 illustrates a single piston air disc brake with reduced taper wear of brake pads, in accordance with an embodiment of the present disclosure; and

FIG. 3 illustrates a carrier member of a single piston air disc brake of FIG. 2, in accordance with an embodiment of the present disclosure.

### DETAILED DESCRIPTION OF THE INVENTION

Throughout this specification, the use of the words “comprise”, “have”, “contain”, and “include”, and variations such as “comprises”, “comprising”, “having”, “contains”, “containing”, “includes”, and “including” may imply the inclusion of an element or elements not specifically recited. The disclosed embodiments may be embodied in various other forms as well.

Throughout this specification, the use of the words “communication”, “couple”, and their variations (such as communicatively) are to be construed as being inclusive of: one-way communication (or coupling); and two-way communication (or coupling), as the case may be.

Throughout this specification, the terms “leading” and “trailing” construed as being inclusive of parts of the brake assuming the usual direction of rotation of a brake disc, i.e. that of a vehicle moving forwards rather than in reverse.

Throughout this specification, the disclosure of a range is to be construed as being inclusive of the lower limit of the range and the upper limit of the range.

Throughout this specification, the words “the” and “said” are used interchangeably with the same meaning.

Also, it is to be noted that embodiments may be described as a method (sequential process). However, many of the operations may be performed in parallel, concurrently, or simultaneously. In addition, the order of the operations may be re-arranged. A method may be terminated when its operations are completed, but may also have additional steps.

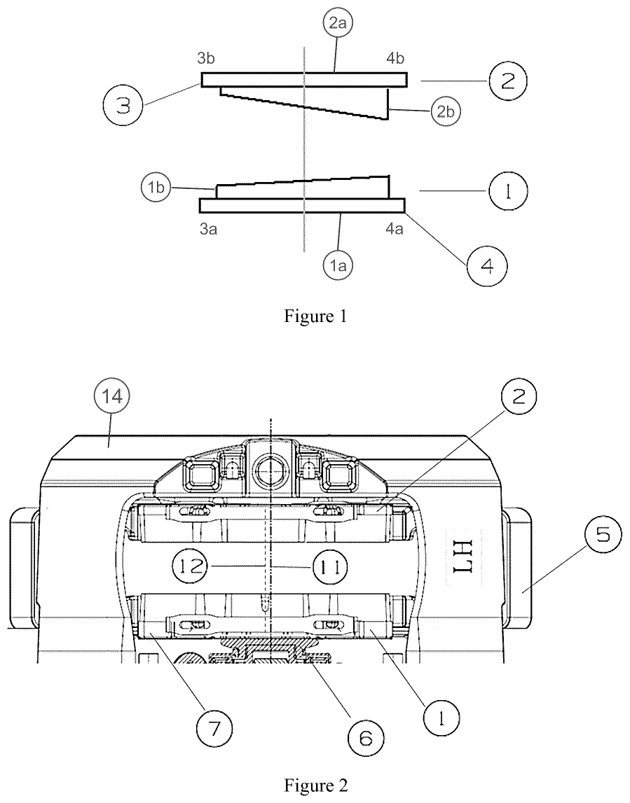

In air actuated disc brakes, brake pads are wearable and replaceable in service. Taper wear of brake pads along their tangential and radial direction are allowed for certain extends. Excess taper wear results in loss of friction usage and thereby causes frequent brake pad change. The brake pads of single piston air disc brakes are prone to taper wear in tangential direction and proportional to the length of the brake pads with respect to a centreline (11; FIG. 2) of a piston (6; FIG. 6). FIG. 1 illustrates brake pads used in a single piston air disc brake with tangential taper wear.

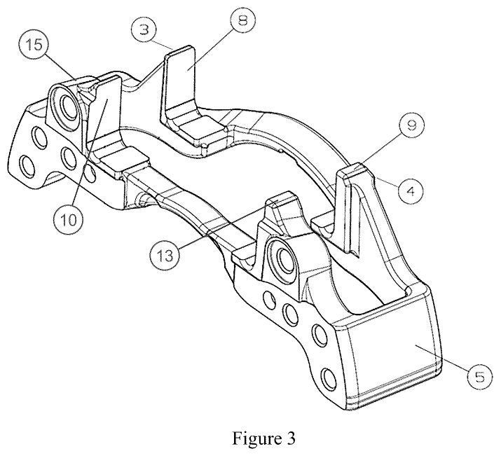

A single piston air actuated disc brake with reduced taper wear of brake pads is disclosed (“disc brake” hereinafter). As illustrated in FIG. 1, FIG. 2, and FIG. 3, said disc brake comprises a caliper (14) disposed on (or disposed in) a carrier (5), which is in turn is associated with a vehicle (not shown).

The disc brake is disposed with a pair of brake pads, namely an inboard pad (1) and an outboard pad (2). The inboard pad (1) comprises a first back plate (la) and a first friction material (1b), and has a first leading edge (3a) and a first trailing edge (4a). Similarly, the outboard pad (2) comprises a second back plate (2a) and a second friction material (2b), and has a second leading edge (3b) and a second trailing edge (4b). An edge of a brake pad at an entry side of a rotor rotational direction is a leading side (3). Similarly, an edge of the brake pad at an exit side of the rotor rotational direction is a trailing side (4).

As illustrated in FIG. 3, the carrier (5) comprises an inboard side, an outboard side, an inboard leading abutment (10), an inboard trailing abutment (13), an outboard leading abutment (8), and an outboard trailing abutment (9). The inboard pad (1) is disposed between the inboard leading abutment (10) and the inboard trailing abutment (13). Similarly, the outboard pad (2) is disposed between the outboard leading abutment (8) and the outboard trailing abutment (9).

During braking, the piston (6) pushes the inboard pad (1) against the rotor, as the inboard pad (1) touches the rotor, the pressure exerts further force and the caliper (14) moves inward and pulls the outboard pad (2) towards the rotor. Both the inboard pad (1) and the outboard pad (2) are pushed against the rotor to generate large amount of force to stop the vehicle.

In an embodiment of the present disclosure, a centreline line (12) of both the inboard pad (1) and the outboard pad (2) are offset towards a leading side (15) of the carrier (5) for a predefined distance from the centreline (11) of the piston (6). Due to the offsetting of the inboard pad (1) and the outboard pad (2) towards a leading side (15) of the carrier (5), the inboard leading abutment (10) and the outboard leading abutment (8) are configured as thinner than the inboard trailing abutment (13) and the outboard trailing abutment (9), respectively, depending on the offsetting of the inboard pad (1) and the outboard pad (2).

In another embodiment of the present disclosure, the predefined distance is between 3 mm and 10 mm.

In yet another embodiment of the present disclosure, offsetting of the centreline line (12) of both the inboard pad (1) and the outboard pad (2) towards the leading side (15) of the carrier is dispensed with. Hence, the centreline (11) of the piston (6) and the centreline (12) of the inboard pad (1) and the outboard pad (2) are the same. The thickness of the inboard leading abutment (10) and the thickness of inboard trailing abutment (13) are the same. Similarly, the thickness of the outboard leading abutment (8) and the outboard trailing abutment (9) are the same. The thickness of the first back plate (la) of the inboard pad (1) is configured as about 1.5 times to about 2 times (i.e. between 1.5 times and 2 times, both inclusive) thicker (7; as in FIG. 2) than the thickness of the second back plate (2a) of the outboard pad (2).

The disclosed single piston air disc brake is configured to reduce the taper wear of brake pads, thereby increases the life of the brake pads.

It will be apparent to a person skilled in the art that the above description is for illustrative purposes only and should not be considered as limiting. Various modifications, additions, alterations and improvements without deviating from the spirit and the scope of the disclosure may be made by a person skilled in the art.

Such modifications, additions, alterations and improvements should be construed as being within the scope of this disclosure.

### LIST OF REFERENCE NUMERALS

1—Inboard Pad
1a—First Back Plate
1b—First Friction Material
2—Outboard Pad
2a—Second Back Plate
2b—Second Friction Material
3—Leading Side
4—Trailing Side
5—Carrier
6—Piston
7—Thicker Back Plate
8—Outboard Leading Abutment
9—Outboard Trailing Abutment
10—Inboard Leading Abutment
11—Centreline of the Piston
12—Centreline of the Brake Pad
13—Inboard Trailing Abutment
14—Caliper
15—Leading Side of the Carrier

1. A single piston air actuated disc brake with reduced taper wear of brake pads, comprising:
a caliper (14); a piston (6);
a carrier (5) that comprising an inboard side, an outboard side, an inboard leading abutment (10), an inboard trailing abutment (13), an outboard leading abutment (8), and an outboard trailing abutment (9);
an inboard pad (1) that comprises a first back plate (la) and a first friction material (1b), and has a first leading edge (3a) and a first trailing edge (4a), with said inboard pad (1) being disposed between the inboard leading abutment (10) and the inboard trailing abutment (13) of the carrier (5);
an outboard pad (2) that comprises a second back plate (2a) and a second friction material (2b), and has a second leading edge (3b) and a second trailing edge (4b), with said outboard pad (2) being disposed between the outboard leading abutment (8) and the outboard trailing abutment (9) of the carrier (5),
wherein
a centreline line (12) of both the inboard pad (1) and the outboard pad (2) being offset towards a leading side (15) of the carrier (5) for a predefined distance from the centreline (11) of the piston (6);
the inboard leading abutment (10) and the outboard leading abutment (8) being configured as thinner than the inboard trailing abutment (13) and the outboard trailing abutment (9), respectively; and
the thickness of first back plate (la) of the inboard pad (1) is configured as 1.5 times to 2 times thicker than the thickness of the second back plate (2a) of the outboard pad (2).

2. The single piston air actuated disc brake with reduced taper wear of brake pads as claimed in claim 1, wherein the predefined distance is between 3 mm and 10 mm.

3. The single piston air actuated disc brake with reduced taper wear of brake pads as claimed in claim 1, wherein the single piston air disc brake is wherein:
offsetting of the centreline line (12) of both the inboard pad (1) and the outboard pad (2) towards the leading side (15) of the carrier is dispensed with;
the thickness of the inboard leading abutment (10) and the inboard trailing abutment (13) being the same, and the thickness of the outboard leading abutment (8) and the outboard trailing abutment (9) being the same; and
the thickness of first back plate (la) of the inboard pad (1) is configured as 1.5 times to 2 times thicker than the thickness of the second back plate (2a) of the outboard pad (2).
